(19) United States
(12) Patent Application Publication
(10) Pub. No.: US 2007/0160788 A1
(43) Pub. Date: Jul. 12, 2007

(54) Multilayer container with barrier protection

(76) Inventors: Kenneth C. Wurtzel, Bridgeton, NJ (US); A.B.M. Rashid, Neenah, WI (US); Robert W. Knoll, Neenah, WI (US)

Correspondence Address: SHERIDAN ROSS PC, 1560 BROADWAY, SUITE 1200, DENVER, CO, 80202, US

(21) Appl. No.: 11/329,748

(22) Filed: Jan. 11, 2006

(51) Int. Cl. B32B 27/08

(52) U.S. Cl. 428/35.7

(57) ABSTRACT

A multilayer container having a structural layer of a mixture of a high density polyethylene and a linear low density maleic anhydride modified polyethylene (LLDPE maleic anhydride), preferably in an amount of about 0.01 to about 0.20 percent by weight. The multilayer container has an oxygen barrier layer disposed adjacent the outer structural layer. In a preferred embodiment, the oxygen barrier layer includes EVOH. The LLDPE maleic anhydride facilitates bonding of the structural layer to the oxygen barrier layer.

### BACKGROUND OF THE INVENTION

This invention relates generally to multilayer containers. More specifically, it relates to a multilayer container having an oxygen barrier core layer between two moisture barrier layers, where an adhesive to adhere the moisture barrier layers to the oxygen barrier layer is incorporated into the moisture barrier layer.

Many products that can be filled and stored in plastic containers require carbon dioxide, oxygen, and moisture barrier protection to keep the products fresh for extended periods of time. Such products include, by way of example only, certain carbonated beverages, fruit juices, beer, sauces, ketchup, jams, jellies, and dry foods such as instant coffee and spices. Non-food applications include packaging for sterile medical equipment and ingestible pharmaceuticals including pills and capsules.

Many multilayer containers that provide commercially acceptable levels of barrier protection for a packaged product contain a layer of ethylene vinyl alcohol copolymer (“EVOH”). In addition to providing excellent oxygen and carbon dioxide barrier protection for a sensitive product, the layer of EVOH may also help to keep the packaged product consumer friendly by maintaining its fresh taste or smell. The EVOH may preserve taste by acting as a barrier to certain chemical elements that may effect the products fragrance or flavor. But, despite its many advantages, EVOH can be difficult to use during the manufacture of these multilayer containers because of its inability to bond well with the conventional resins used in these plastic multilayer containers. For example, these multilayer containers typically require use of a separate layer of adhesive material to bond an EVOH layer to other layers of a multilayer barrier container. Thus, a container may have the following exemplary layers: a first layer of polyethylene, a first layer of adhesive, a layer of EVOH, a second layer of adhesive, and a second layer of polyethylene. Because a separate layer of adhesive material is used to bond the polyethylene to the EVOH, the manufacturing process is often more complicated and possibly more expensive.

### BRIEF SUMMARY OF THE INVENTION

The present invention is directed to a multilayer container. According to one exemplary embodiment, the multilayer container has three layers: a first layer defining an outermost layer of the container made from a mixture of polyethylene and a maleic anhydride modified linear low density polyethylene, a second layer made from EVOH, and a third innermost layer made from a mixture of polyethylene and a maleic anhydride modified linear low density polyethylene. The second layer is directly adjacent to the first and third layers. The maleic anhydride in the first and third layers facilitates the adhesion of the first and third layers to the second layer.

### BRIEF DESCRIPTION OF THE SEVERAL VIEWS OF THE DRAWING

The invention is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following figures:

FIG. 1 is a perspective view of a multilayer container according to the present invention;

FIG. 2 is a sectional view of a wall of the container shown in FIG. 1; and

FIG. 3 is a perspective view of a preform according to the present invention that is used to make a multilayer container.

### DETAILED DESCRIPTION OF THE INVENTION

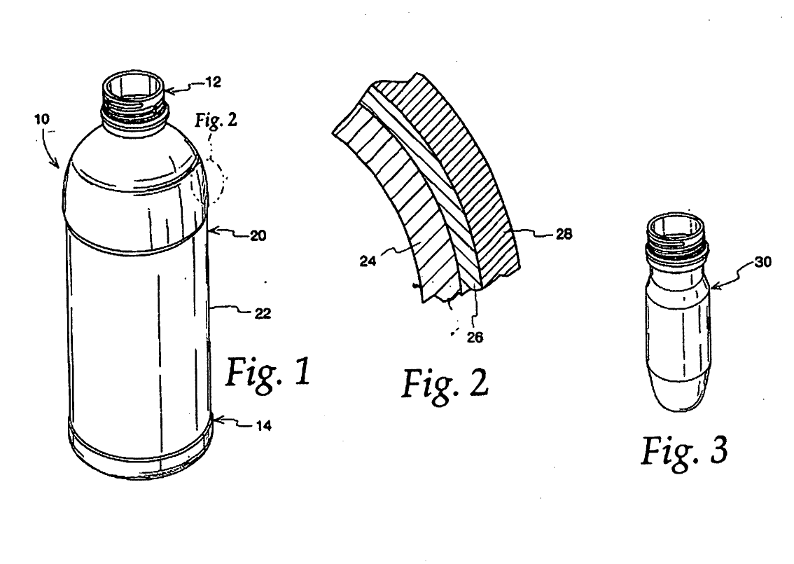

FIG. 1 illustrates a multilayer plastic container, for example a bottle 10, according to an exemplary embodiment of the present invention. The bottle 10 has a top end 12 and a bottom end 14. A body portion 20 extends between the top end 12 and the bottom end 14 and forms a cylindrical wall 22. Although the container illustrated is a bottle, it is noted that various other containers can be made according to the present invention as would be understood by one skilled in the art.

As best illustrated in the cross-sectional view of the cylindrical wall 22 shown in FIG. 2, the bottle 10 is preferably constructed of three layers, namely an inner layer 24, a middle layer 26, and an outer layer 28. According to one embodiment, the inner layer 24 and the outer layer 28, which are structural layers, are made of a material comprising polyethylene.

Polyethylene (PE) is classified into several different categories based mostly on its mechanical properties. The mechanical properties of PE depend significantly on variables such as the extent and type of branching, the crystal structure, and the molecular weight. Categories of polyethylene include, but are not limited to, UHMWPE (ultra high molecular weight PE), HDPE (high density PE), LDPE (low density PE), and LLDPE (linear low density PE).

HDPE has a low degree of branching and thus stronger intermolecular forces and tensile strength. The lack of branching is ensured by making the HDPE with an appropriate choice of catalyst (e.g. Ziegler-Natta catalysts) and reaction conditions.

LDPE has a high degree of branching, and has less strong intermolecular forces, that is, the instantaneous-dipole induced-dipole attraction is less. This results in a lower tensile strength and increased ductility. LDPE may be created by free radical polymerization. LLDPE is a substantially linear polymer, with significant numbers of short branches, commonly made by copolymerization of ethylene with longer-chain olefins.

Items are made according to an embodiment of the present invention by a number of processes, such as co-extrusion blow molding, co-injection blow molding, or co-injection stretch blow molding. The present invention, however, also contemplates a process of making items that are multi-layered but not blow-molded. For example, vials may be made according to an embodiment of this invention by co-injection molding, and performs may also be made by co-injection molding or co-extrusion molding. Additional vessels include performs, which may be co-injection or co-extrusion molded. A preform, a starting structure for co-injection blow molding and co-injection stretch blow molding ware, is smaller in circumference and in its axial direction that its final blown ware counterpart. A perform, which is contemplated by the present invention, is often a desirable form for the embodiment of the present invention because the perform may be shipped more easily to distant locations. The preforms advantageously require less room for shipment than their blown ware counterparts.

According to another exemplary embodiment, the inner layer 24 and the outer layer 28, which are structural layers, are made of a material that is extrusion blow moldable or co-injection blow moldable and which comprises at least a high density polyethylene (HDPE). An exemplary HDPE has a density between about 0.941-0.965 g/cm³ and is suitable for use at temperatures below 180° C. Typically, those with a density of 0.960 and above would be HDPE homopolymers. Those with a density below 0.960 would likely be HDPE copolymers. Exemplary high density polyethylene of the present invention include those with a fractional melt index (ASTM D1238: 190° C., 2160 g applied load) and those having a melt index of up to and including about 2, depending on the size and shape of the desired extrusion blow moldable or co-injection blow moldable container desired. HDPE having a melt index greater than 2 could also be applicable in some situations. Exemplary polyethylene include those ethylenes sold under the Marlex® name manufactured by Chevron Phillips Chemical Co., LLP, more specifically, Marlex® HHM 5502BN and those ethylenes sold under the Petrothene® name manufactured by Equistar, namely, LR 7320-01.

According to yet another exemplary embodiment, the inner layer 24 and the outer layer 28, which are structural layers, are made of a material comprising at least a high density polyethylene (HDPE) and a colorant. The colorant reduces light transmittance. One standard for measuring light transmittance is the USP test for Light Resistant Containers. Exemplary containers of the present invention for applications where transparency is not desired would allow no greater than 10% transmission of light having a wavelength between 290-450 nm.

Exemplary colorants include, but are not limited to, titanium dioxide white concentrates such as those manufactured by Plastics Color Corporation, Inc. (PCC). An exemplary colorant is PCC's PEC 14828. The colorant is defined with a “let down” ratio, i.e., the amount of colorant to be used in an amount of resin when molding ware. An exemplary let down ratio of a colorant of the present invention is 6 lbs./100 lbs. of molding resin. This ratio will yield a titanium dioxide loading of about 1-5%, for example 2.9%, in the HDPE layer of the multilayer container.

The wall thickness of the multilayer container also impacts light transmittance. The preferred total multilayer container wall thickness is greater than 10 mils, for example, between about 20-100 mils, or more preferably between about 30-35 mils. A multilayer container having a wall thickness of 35 mils and a titanium dioxide loading of 2.5% consistently passes the USP test for Light Resistant Containers.

The middle layer 26 is preferably made of a material comprising at least an ethylene vinyl alcohol copolymer (EVOH). An exemplary EVOH would include those manufactured by Nippon Gohsei and sold under the name Soarnol®, and those manufactured by Dupont and sold under the name Selar® OH. The middle layer 26 provides carbon dioxide and oxygen barrier resistance that allows a product to be stored within the bottle 10 for an extended period of time without spoiling. Note that although the middle layer 26 is preferably made of a material comprising EVOH, the middle layer can comprise any appropriate barrier material, such as nylon or a blend of ethylene vinyl alcohol copolymer and nylon. An appropriate nylon is exemplified by MXD6, nylon 6, and nylon 6/66. An appropriate adhesive (discussed in detail below) is chosen dependent upon the material of the middle layer 26 to bond the inner and outer layers 24 and 28 thereto.

The inner and outer layers 24 and 28 are the structural layers of the bottle and provide moisture barrier protection, for example, water vapor, for the product to be contained in the bottle 10. The thickness of the inner and outer layers 24 and 28 and the thickness of the middle layer 26 are determined by factors such as the type of product to be stored in the container, and the desired shelf life of the product, etc. Typically, the thickness of the layers are in the range of between approximately 5 mils to 10 mils for each of the inner and outer layers 24 and 28 and between approximately 0.1 mils to 3.0 mils for the middle layer 26.

The bottle 10 can be stretch blow molded from a preform 30 (FIG. 3), by using conventional stretch blow molding techniques. Alternatively, other techniques to form bottle 10 include, for example, injection blow molding and extrusion blow molding as would be understood by one of ordinary skill in the art. In one embodiment, the preform 30 is made by an injection molding process such as the injection molding processes described in U.S. Pat. Nos. 4,511,528 and 4,712,990, which are hereby incorporated by reference. Alternatively, the bottle may be made by extrusion blow molding techniques such as the process described in U.S. Pat. No. 5,156,857, which is hereby incorporated by reference.

With regard to injection molding applications, the process temperatures of polyethylene and EVOH are approximately the same. Therefore, the process temperatures of the materials to comprise the inner and outer layers 24 and 28 and the materials to comprise the middle layer 26 are also approximately the same despite the addition of an adhesive (discussed in detail below) to at least one of the inner and outer layers 24 and 28 and/or the middle layer 26. Accordingly, it is easier to maintain proper flow temperatures for the material forming each layer 24, 26, 28 and, therefore, control the flows of these layers having only two different materials as opposed to controlling five layers of three distinct materials (i.e., polyethylene, adhesive, and EVOH) which may have different process temperatures. The process temperature of the polyethylene and EVOH is approximately between 180°-235° C. (with or without the adhesive discussed in detail below).

In order to bond each of the inner and outer layers 24 and 28 to the middle layer 26, the material of at least one of the inner and outer layers 24 and 28 comprises an adhesive mixed therein. Thus, according to one exemplary embodiment of the present invention, the inner and outer layers 24 and 28 may comprise a mixture of polyethylene or ethylene with an adhesive (“polyethylene/adhesive mixture”) while the middle layer 26 is comprised of EVOH without an added adhesive. Examples of this embodiment are provided below.

In a further embodiment, the inner and outer layers 24 and 28 are made of the polyethylene/adhesive mixture, for example, an HDPE/adhesive, and the middle layer is made of the EVOH. Still yet a further embodiment includes adding a colorant to the HDPE/adhesive inner and/or outer structural layers.

Sufficient adhesion for purposes of this invention means achieving a bond between the middle layer 26 and each of the inner and outer layers 24 and 28 to prevent delamination during forming of the bottle 10 or other container and withstanding normal package handling and distribution. The amount of adhesive used must also provide sufficient adhesion for purposes of injection molding the preform and stretch blow molding the container from the preform. Importantly, using the lowest possible percentage of adhesive is desirable because the adhesive is relatively expensive compared to polyethylene.

It has been found that the greater the percentage of adhesive evenly distributed within any layer of the bottle 10 (referred to herein as a “mixed-adhesive layer”), the better that layer will adhere to an adjacent layer. This correlation is believed to be due to two facts. First, the adhesive force that a mixed-adhesive layer may exert on an adjacent layer of a container depends, at least in part, upon the amount of adhesive available at the outer surface of that mixed-adhesive layer. Second, as the percentage of adhesive agent evenly mixed and distributed throughout any composite material used to construct a mixed-adhesive layer is increased, the amount of adhesive agent which will be exposed at an outer surface of that mixed-adhesive layer (and thereby made available for adhesion to an adjacent layer) will also necessarily increase. Additionally, the percentage of the adhesive agent in the mixed-adhesive layer, which is exposed at the outer surface of that mixed-adhesive layer, is inversely proportional to the thickness of that mixed-adhesive layer. That is, a thinner mixed-adhesive layer will produce greater adhesive potential from a given quantity of adhesive agent, than will a relatively thicker mixed-adhesive layer comprised of the same given quantity of adhesive agent.

From the foregoing it will be understood that because the middle layer 26 of the present invention is thinner (preferably between 0.1 and 3.0 mils) than each of the outer layers 24 and 28 (preferably between 5 mils and 10 mils), mixing an adhesive into the middle layer 26, as in one embodiment of the present invention, will necessarily decrease the amount of adhesive necessary to bond the inner and outer layers 24 and 28 to the middle layer 26 relative to another embodiment of the present invention in which the adhesive is dispersed within the inner and outer layers 24 and 28. Moreover, because one embodiment of the present invention only requires adhesive to be mixed into a single layer rather than into two layers (as required by an embodiment of the present invention described above), the total quantity of adhesive required for this embodiment is further reduced relative to the quantity of adhesive required for another embodiment. Regardless of which embodiment of the present invention is employed, however, the amount of adhesive required to acquire the requisite bonding of the middle layer 26 to both the inner and outer layers 24 and 28 is reduced relative to prior methods of bonding polyethylene or HDPE to EVOH which place an entire layer of adhesive between each of the inner and outer layers 24 and 28 and the middle layer 26. Moreover, as discussed above, the complexity of molding preforms to achieve such bonding is likewise reduced by elimination of the adhesive layers.

In one embodiment of the present invention, bottles are made having a haze value of less than approximately 29%. In another embodiment, the bottles have a haze value of 10-12%. A haze value is defined as the percent of total light which, in passing through the specimen, deviates through forward scatter by more than 0.044 rad (2.5°) on the average. The preferred test to obtain the haze value of the bottle is ASTM Method D-1003 as defined in the 1995 Annual Book of ASTM Standards, Volume 8.01. According to one embodiment as discussed above, a colorant is added to the inner and outer layers 24 and 28 to obtain a desired haze value of the bottle.

The adhesive used to make the polyethylene/adhesive mixture for an embodiment of the present invention is a maleic anhydride modified linear low-density polyethylene (LLDPE) resin. Exemplary LLDPE adhesives include the Bynel® 4100 Series adhesive resins manufactured by DuPont de Nemours International S.A., such as Bynel® 41E710. The amount of adhesive that must be blended into the polyethylene depends on the maleic anhydride concentration of the adhesive. Enough adhesive must be added such that the resulting polyethylene/adhesive mixture has a maleic anhydride content of approximately 0.01%-0.20% by weight of the total mixture. (For example: 10% of adhesive containing 0.15% maleic anhydride.) The polyethylene/adhesive mixture can contain between 0-98% by weight polyethylene and between 2-100% by weight adhesive. It has been found that the greater the percentage of adhesive used, the better the layer of EVOH will adhere to the structural layer. However, it has been found that sufficient adhesion between the layers is achieved using polyethylene/adhesive mixtures containing as low as approximately 0.01%-0.015% maleic anhydride. The middle layer 26, according to one exemplary embodiment, is comprised of EVOH without the presence of an adhesive therein.

### EXAMPLES

The following are exemplary embodiments of the invention having the inner and outer layers 24 and 28 comprised of an HDPE/adhesive mixture layer.

### Example 1

A three-layer co-extrusion molded preform was made having inner and outer structural layers 24 and 28 which are made from a HDPE/adhesive mixture containing about 95% HDPE and 5% adhesive and a middle layer 26 of EVOH. The HDPE was Chevron Phillips HHM 5502BN. The adhesive was DuPont Bynel® 41E710. The EVOH selected for the middle layer 26 was EVAL L-171 manufactured by Kuraray Co. Ltd. (having a 27% molar ethylene content).

### Example 2

A three-layer co-extrusion molded preform was made as in Example 1 except that a colorant was added to the inner and outer structural layers 24 and 28. The colorant was PEC 14828 manufactured by Plastics Color Corporation, Inc.

Also, it will be understood that modifications can be made to the three-layered polyethylene containers having a moisture barrier layer as the outer and inner layer and an oxygen barrier layer as the middle layer of the present invention without departing from the teachings of the invention. Accordingly the scope of the invention is only to be limited as necessitated by the accompanying claims.

What is claimed:

1. A container comprising:
a first moisture barrier layer comprising polyethylene and defining an outermost layer of the container; and
an oxygen barrier layer directly adjacent to the first layer;
a second moisture barrier layer comprising polyethylene and defining an innermost layer of the container, wherein
one or both of the first moisture barrier layer and the second moisture barrier layer comprises a mixture of polyethylene and a linear low density maleic anhydride modified polyethylene, the maleic anhydride facilitating bonding of the oxygen barrier layer between the first and second moisture barrier layers.

2. The container of claim 1 wherein the first layer contains approximately 0.015 wt % maleic anhydride.

3. The container of claim 1 wherein the first layer is a structural layer.

4. The container of claim 1 wherein the oxygen barrier layer comprises EVOH.

5. The container of claim 1 wherein the oxygen barrier layer is comprised of a material selected from the group consisting of nylon 6, nylon 6/66, EVOH, PVdC, and combinations thereof.

6. The container of claim 1 wherein a layer comprises a colorant.

7. The container of claim 1 wherein the container has a wall thickness in the range of 20-100 mils.

8. The container of claim 7 wherein the wall thickness is about 35 mils.

9. The container of claim 1 wherein the container allows no greater than 10% transmission of light having a wavelength in the range of 290-450 nm.

10. The container of claim 1 wherein the one or both moisture barrier layers having maleic anhydride comprises about 0.01 to about 0.20 percent by weight maleic anhydride.

11. A multilayer container comprising:
a first layer defining an innermost layer of the container and comprising a mixture of polyethylene and a linear low density maleic anhydride modified polyethylene; and
a second layer comprising a material selected from the group consisting of EVOH and polyamide, directly adjacent to the first layer;
the maleic anhydride facilitating bonding between the first layer and the second layer.

12. The container of claim 11 wherein the first layer contains approximately 0.015% maleic anhydride.

13. The container of claim 11 wherein the first layer is a structural layer.

14. The container of claim 11 wherein the second layer comprises EVOH.

15. The container of claim 11 wherein the second layer comprises nylon 6.

16. The container of claim 11 wherein the second layer comprises nylon 6/66.

17. The container of claim 11 further comprising a third layer comprised of polyethylene and maleic anhydride, said third layer defining an outermost layer of the container.

18. The container of claim 11 further comprising a third layer comprised of polyethylene directly adjacent to the second layer.

19. The container of claim 18 wherein the third layer further comprises maleic anhydride.

20. The container of claim 18 wherein the third layer defines an outermost layer of the container.

21. The container of claim 11 wherein the first layer comprises a colorant.

22. The container of claim 11 wherein the container has a wall thickness in the range of 20-100 mils.

23. The container of claim 22 wherein the wall thickness is about 35 mils.

24. The container of claim 11 wherein the container allows no greater than 10% transmission of light having a wavelength in the range of 290-450 nm.

25. The container of claim 11 wherein said first layer comprises about 0.01 to about 0.20 percent by weight maleic anhydride.

26. A multilayer container comprising:
a first structural layer defining an innermost layer of the container and comprising a mixture of polyethylene, a colorant, and a linear low density maleic anhydride modified polyethylene in an amount of from about 0.01 to about 0.20 percent by weight maleic anhydride;
a second layer comprising a material selected from the group consisting of EVOH and nylon; and
a third structural layer defining an outermost layer of the container and comprising a mixture of polyethylene, a colorant, and a linear low density maleic anhydride modified polyethylene in an amount of from about 0.01 to about 0.20 percent by weight maleic anhydride;
wherein the maleic anhydride facilitates bonding of the second layer between the first and third structural layers.
